(19) United States
(12) Patent Application Publication
(10) Pub. No.: US 2025/0290173 A1
(43) Pub. Date: Sep. 18, 2025

(54) METHOD FOR PROCESSING MATERIALS CONTAINING IRON AND ZINC

(71) Applicant: ZINCOVERY PROCESS TECHNOLOGIES LIMITED, Christchurch (NZ)

(72) Inventors: Aaron Timothy Marshall, Christchurch (NZ); Ben Houlton, Christchurch (NZ); Leatham Landon Lane, Christchurch (NZ)

(73) Assignee: ZINCOVERY PROCESS TECHNOLOGIES LIMITED, Christchurch (NZ)

(21) Appl. No.: 18/860,917

(22) PCT Filed: Apr. 28, 2023
(86) PCT No.: PCT/IB2023/054400

§ 371 Date: Oct. 28, 2024

(30) Foreign Application Priority Data
Apr. 29, 2022 (NZ) 787665

(51) Int. Cl. C22B 5/12; C22B 7/00; C22B 19/30

(52) U.S. Cl. CPC C22B 5/12; C22B 7/007; C22B 19/30

(57) ABSTRACT

A method for processing a source material containing zinc ferrite that includes the following step: B. Partially reduce source material using a reducing gas containing hydrogen to form a reduced material; where step B is carried out at below 1000° C. using a reducing gas containing at least 0.25% (by vol.) and up to 70% (by vol.) hydrogen in a carrier gas.

### TECHNICAL FIELD

The present invention relates to a method for processing iron/zinc materials that contain zinc ferrite, for example iron/zinc dusts such as electric arc furnace dust, which includes a controlled reduction step.

### BACKGROUND ART

Electric Arc Furnace Dust (EAFD) is produced in large quantities in the steel industry, about 20 kg per ton of steel, annually. This means that over 8 million tonnes of EAFD is produced annually. EAFD contains iron and zinc and other valuable metals such as cobalt, copper, chromium and cadmium.

The composition of EAFD varies, however it tends to contain, by weight, 10% to 50% zinc, 20% to 50% iron; with 3% to 20% calcium, up to 4% chromium, up to 6% manganese and up to 5% magnesium. Some of the zinc is present in an easily accessible ZnO form, however a significant proportion is present as zinc ferrite (ZnFe₂O₄) from which zinc extraction is difficult. The processes which dissolve zinc ferrite directly carry both the zinc and a significant proportion of the iron into solution which makes the separation processes to extract the zinc more complex.

The EAFD is a particulate material which is all generally less than 100 micron, and most often has only 10% to 15% of particles above 10 micron. With a significant (>85%) proportion of EAFD less than 10 micron, there is a high risk of entrainment in a moving gas stream, and this can make handling and processing problematic. Pelletisation of the EAFD, often with carbon, is normally undertaken to reduce entrainment and other problems associated with a finely divided feed material and WO2000039351A1 suggests that this is necessary. This pelletisation is an additional cost step that may make some EAFD processes uneconomical long term. Carbon is often used as part of the pellet binder which can increase the release of CO₂ during the processing of the pelletised EAFD which is becoming environmentally challenging.

If the EAFD is pelletised there is the increased risk that any processing steps could be limited by diffusion effects resulting in differential processing through the pellet. Though pelletisation has been found to improve heat transfer in some cases. This diffusion problem can be partially or completely mitigated by carefully sizing the pellet and/or pellet composition to maintain porosity. The risk is that to maintain structural integrity of a high porosity pellet they may become brittle and breakdown mechanically (or thermo-mechanically) during processing.

The most common method of recovering the zinc from EAFD which uses pelletisation with carbon is called the Waelz process. The Waelz process uses carbon as a reductant to produce zinc metal which at the temperatures used (1000° C. to 1500° C.) is formed as a vapour. The zinc vapour produced is then reacted with an air/oxygen stream to form zinc oxide which is then leached to form zinc rich liquors from which the zinc is recovered.

The Waelz process, and many other recovery processes first pelletise the EAFD with carbon and a binder, see for example U.S. Pat. No. 4,612,041 (Sumitomo Heavy Industries) and U.S. Pat. No. 3,262,771 (Ban) and PL406290. The process then involves the injection of a carbon rich reducing gas, for example carbon monoxide, methane or similar, to reduce the metals present. The pelletisation reduces the dust movement problems but carbon in the process generates significant amounts of carbon dioxide.

A further problem with the Waelz process, and those based on it, is the production of a zinc vapour which can cool, often below the boiling point of zinc causing condensation and potentially solidification of the zinc, prior to reaction with the oxygen or air. If the zinc condenses or solidifies then it can block or constrict the flow out of the processing vessel and require mechanical removal. Zinc vapour is also believed to shorten the life of furnace linings.

To mitigate the condensation of zinc CN109457123 includes a lead rain condenser, which is only practical if there is sufficient lead in the feed material processed.

There are many scientific studies and patents relating to the processing of EAFD, and many of these use synthetic EAFD made up of zinc ferrite and zinc oxide. Unfortunately, real EAFD does not behave like these synthetic EAFD's and taking the lab scale results from synthetic EAFD experiments often does not work. For example, real EAFD can contain up to 5% halides and 1% carbon by weight. One paper that considers the difference between real EAFD and synthetic EAFD is Lee Fui Tong & Peter Hayes (2006) Mechanisms of the reduction of zinc ferrites in H2/N2 gas mixtures, Mineral Processing and Extractive Metallurgy Review, 28:2, 127-157, DOI: 10.1080/08827500601012878.

Many of the existing methods of processing EAFD result in the formation of elemental iron and iron oxide which dissolve in acidic leach steps. This iron in the leachate is problematic as it increases the difficulty and/or cost to recover the zinc. Given the problems acid leaching creates some researchers do not consider the use of acidic leaching viable commercially, especially using sulphuric acid. See J. Antrekowitsch, H. Antrekowitsch, Hydrometallurgically recovering zinc from electric arc furnace dusts, JOM. 53 (2001) 26-28. https://doi.org/10.1007/s11837-001-0008-9, for example.

Lee, Han-Saem & Park, Da & Hwang, Yuhoon & Ha, Jong & Shin, Hyung. (2019). Toward high recovery and selective leaching of zinc from electric arc furnace dust with different physicochemical properties. Environmental Engineering Research. 25. 10.4491/eer.2019.132. indicates that alkaline leaches have a higher cost than acidic leaches, however acidic leaches carry higher levels of iron into solution which is undesirable thus they have not been widely adopted. They indicate that ‘Another disadvantage of the acid leaching process is the simultaneous leaching of Fe with Zn [5]. Among the various forms of Zn in EAFDs [3, 6], ZnFe₂O₄ is highly resistant to dissolution under normal acid leaching conditions. Therefore, Zn recovery from ZnFe₂O₄ has required harsher conditions, including high temperatures, high pressures, and high acid concentrations during leaching [12]. However, these methods suffer from large amounts of Fe leaching and high energy costs.’ They suggest selecting optimum EAFD by the Fe/Zn ratio and using sulphuric acid with a pH of >4.5 to minimise Fe dissolution. This process selects EAFD with low zinc ferrite levels as these have high levels of ZnO which is easy to leach at the conditions that result in low iron dissolution.

Zhang, C., Zhuang, L., Wang, J., Bai, J., & Yuan, W. (2016). Extraction of zinc from zinc ferrites by alkaline leaching: enhancing recovery by mechanochemical reduction with metallic iron. Journal of the Southern African Institute of Mining and Metallurgy, 116 (12), 1111-1114. https://dx.doi.org/10.17159/2411-9717/2016/v116n12a3J, discusses the mechanochemical reduction of zinc ferrite using iron then an alkaline leaching step to minimise the iron in the leachate. This requires that the zinc ferrite is ground in a ball mill for 6 hours before leaching the resultant material with 6M NaOH. It is uncertain if the same results would be obtained from EAFD due to the impurities present.

Antrekowitsch, H. Antrekowitsch, Hydrometallurgically recovering zinc from electric arc furnace dusts, JOM. 53 (2001) 26-28. https://doi.org/10.1007/s11837-001-0008-9, finds that the use of hydrogen/nitrogen reducing gases, with 50% hydrogen, on EAFD is successful at recovering 100% of the zinc if a caustic leach is used. The caustic leaching step is required as there are very high levels of iron in acid soluble forms present following the reduction step. Sulphuric acid, acid leaching, results in a leachate with high iron contamination which increases the cost and complexity of recovering any zinc present. They further noted that the zinc recovery fell when the reducing gas had less than 50% hydrogen, zinc recovery dropping to 50% when the reducing gas was about 10% hydrogen. With an alkaline leaching step and high hydrogen levels the process can recover essentially all of the zinc from an EAFD. As indicated earlier the use of an alkaline leaching step has a higher cost than an acidic leaching step, however this avoids the dissolution of iron into the leachate. For this process the hydrogen content of the reducing gas needs to be around 50% to have a good result. This high level of hydrogen poses a significant fire/explosion risk and increases the cost.

Other industrial processes create material containing zinc ferrite, these industries include the mining and refining of zinc ore, and the zinc is generally recovered by using alkaline or acid leaching solutions often heated to over 100° C. These aggressive leaching processes often result in highly corrosive waste solutions that need to be recovered or disposed of, this is often expensive or environmentally damaging, sometimes both.

Any discussion of the prior art throughout the specification is not an admission that such prior art is widely known or forms part of the common general knowledge in the field.

The present invention provides a method of processing an EAFD that reduces the zinc ferrite without producing significant amounts of acid soluble iron or zinc vapour, or provides the consumer with a useful choice.

### DISCLOSURE OF INVENTION

The present invention provides a method for processing a source material containing zinc ferrite that includes the following step in order:
B. Partially reduce source material using a reducing gas containing hydrogen to form a reduced material;
   where step B is carried out at or below 1000° C. using a reducing gas containing at least 0.25% (by vol.) hydrogen in a carrier gas.

Preferably step B is carried out at or below 800° C.

Preferably no more than 70% (by vol.) hydrogen in the reducing gas. In a highly preferred form there is no more than 60% hydrogen (by vol.) in the reducing gas.

Preferably the source material is a particulate material that is not pelletised before processing.

Preferably the source material is from the steel or iron manufacturing industry, or the zinc mining and/or refining industry. Preferably the waste material is from a furnace. In a highly preferred form the source material is Electric Arc Furnace Dust (EAFD).

In an alternative preferred form the source material is from the zinc industry. In a highly preferred form the source material is zinc mining or refining waste material.

Preferably step B is carried out at between 500° C. and 750° C. In a highly preferred form the temperature in step B is no more than 700° C. In a further preferred form the temperature in step B is no more than 650° C. In a further preferred option the temperature is at least 650° C. Preferably the temperature in step B is no more than a temperature selected from the group consisting of 550° C., 600° C., 650° C. and 700° C.

Preferably the temperature in step B is no less than a temperature selected from the group consisting of 550° C., 600° C. and 650° C.

Preferably the method includes a step C, where step C cools the reduced material to a temperature no higher than 350° C. in an inert or reducing gas environment.

Preferably the hydrogen content of the reducing gas is between 0.25% and 10% by volume.

Preferably there is a step A preceding step B, where in step A the source material is analysed to determine the total zinc and/or zinc ferrite concentrations. In a highly preferred form the total zinc is at present determined by X-Ray Fluorescence (XRF) or a standard chemical analysis and the zinc ferrite fraction by X-Ray Diffraction.

In a highly preferred form step A determines proposed processing conditions to be used in step B, including reduction time (Rt), reduction temperature (RT) and reducing gas flowrate (GF). Preferably step A includes a bench scale test to confirm the proposed processing conditions result in less than 10% mass loss, and preferably no more than (2+/−0.5) % mass loss. In a further preferred form step A confirms that any wustite and/or metallic iron produced under the proposed processing conditions is below predetermined values.

In a preferred form the reducing gas also includes water. Preferably the water is added at a predetermined time after step B commences. Preferably this predetermined time is before the temperature in step B has reached 650° C. In a further preferred form the temperature is selected from the list consisting of 500° C., 550° C., 600° C. and 650° C. In an alternative preferred form the predetermined time occurs when the temperature is within a range of temperatures selected from the list consisting of 500° C. to 550° C., 550° C. to 600° C., 600° C. to 650° C., 500° C. to 600° C. and 500° C. to 650° C. In a highly preferred form the ratio of water to hydrogen (H₂O:H₂), on a molar basis, is between 20:1 and 1:5. Preferably the water to hydrogen ratio is between 1:2 and 2:5. In a highly preferred form the water to hydrogen ratio is between 5:1 and 1:1.

In alternative forms the reducing gas further includes carbon monoxide such that the molar ratio of H₂:H₂O:CO is 2:(1 to 10):(0 to 10) at a concentration of between 0.25% to 15% (by volume) in the carrier gas.

Preferably the carrier gas is a neutral carrier gas selected from the list consisting of nitrogen, helium and argon. In alternative forms the neutral carrier gas a combination of one or more gases selected from the list consisting of nitrogen, helium and argon. Preferably the neutral carrier gas is an inert gas.

Preferably after step C there is a step D, where step D is an acid leaching step. Preferably the acid leaching step uses an acid leach which includes one or more acids selected from the list consisting of sulphuric acid, phosphoric acid, hydrochloric acid, hydrofluoric acid, and an organic acid with less than 15 carbon. In a highly preferred step D is carried out at a pH of less than 3, and preferably at 2. Preferably the acid leach used contains sulphuric acid. In a highly preferred form the acid leach is sulphuric acid.

Preferably step B is monitored and/or controlled by directly or indirectly measuring the extent of reduction by determining the forms of iron present, and/or determining the composition of the reducing gas within the furnace and/or an exiting gas stream. Preferably by determining the composition of the exiting gas stream using a Thermal Conductivity Detector.

### BRIEF DESCRIPTION OF DRAWINGS

By way of example only, a preferred embodiment of the present invention is described in detail below with reference to the accompanying drawings, in which:

FIG. 1 is a flowchart of the method:

FIG. 2 is a H₂/H₂O phase equilibria diagram for various iron forms at various temperatures:

FIG. 3 is a CO/CO₂ phase equilibria diagram for various iron forms at various temperatures:

FIG. 4 is a TCD (Thermal Conductivity Detector) graph comparing various water to hydrogen ratios with a synthetic Electric Arc Furnace Dust (EAFD);

FIG. 5 is a TCD (Thermal Conductivity Detector) graph comparing real Electric Arc Furnace Dust (EAFD) to a synthetic Electric Arc Furnace Dust (EAFD); and

FIG. 6 is a TCD (Thermal Conductivity Detector) graph comparing synthetic Electric Arc Furnace Dust (EAFD) to a real Electric Arc Furnace Dust (EAFD).

### DEFINITIONS

EAFD: Electric Arc Furnace Dust.
FRANKLINITE: Some references use the term franklinite to refer to ZnFe₂O₄ (zinc ferrite) present in EAFD due to the form being similar. In many EAFD's (and the mineral form) franklinite contains ZnFe₂O₄ and ZnMnFeO₄, as such herein where franklinite is used it contains zinc ferrite and may contain ZnMnFeO₄.
MAGNETITE: Fe₃O₄
SULPHURIC ACID: this is intended to include oleum.
Water: this term is intended to include all fluid forms of water such as water vapour (steam) and liquid water as determined by the local environmental conditions.
WUSTITE: sometimes called non-stoichiometric iron oxide (Fe_{0.947}O), both Fe(II) and Fe(III) are present in the oxide. Sometimes written as FeO.
ZINCITE: essentially zinc oxide (ZnO).

As the materials being processed by this method are complex where a chemical formula is used this may simply be to refer to the predominant species present.

For clarity the term ‘about’ is normally used when the parameter is within +/−15%, and ‘approximately’ is used when the parameter is within +/−10%, unless specified otherwise.

First Mode for Carrying out the Invention

Though described with reference to EAFDs the method is believed to be applicable to other zinc rich dusts from the steel or iron making process, for example dust from basic oxygen furnaces, where ZnFe204 is present. It is also felt that any process or industry that produces material containing zinc ferrite could also use the method to recover zinc, for example material from the mining and refining of zinc ore.

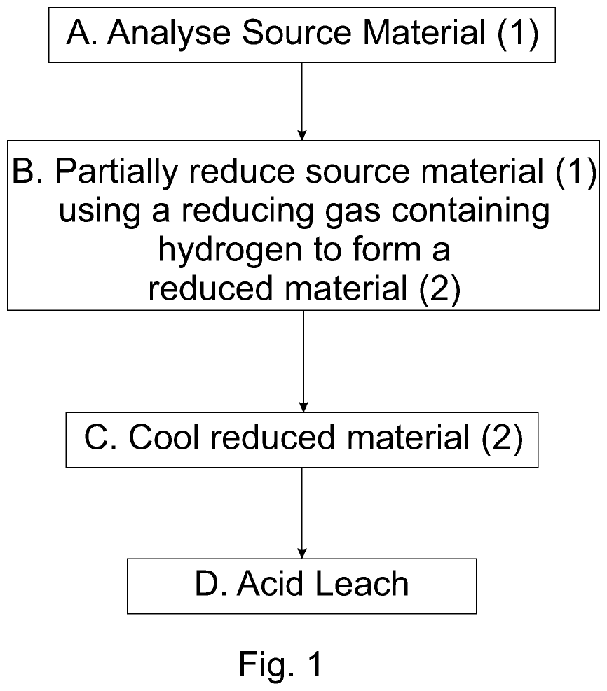

Referring to FIG. 1 the core steps of the method for processing a source material (1), most likely EAFD, are shown in the form of a flowchart.

For this variant the steps, in order, are:
A. Analyse the source material (1);
B. Partially reduce source material (1) using a reducing gas (2) containing hydrogen to form a reduced material (3);
C. Cool reduced material (3); and
D. Acid leach reduced material (3).

Step A is optional and will not be present in all variations, it is at present used to determine the optimum processing variables. Steps C and D are preferred but also optional.

Step A is the analysis of the source material (1) to determine the amount of zinc and zinc ferrite present so that the processing parameters can be determined. These parameters include the reduction temperature (RT), the reduction time (Rt), the hydrogen concentration (HC) of the reducing gas (2) and the reducing gas (3) flowrate (GF). Total zinc is at present determined by X-Ray Fluorescence (XRF) or a standard chemical analysis and the zinc ferrite fraction by X-Ray Diffraction.

Once step A has been completed the reduction conditions in step B can be determined. The aim is to reduce the zinc ferrite to magnetite and zinc oxide whilst avoiding the formation of wustite, iron or zinc. Wustite and iron are soluble in acid and as zinc is molten at around 420° C. this can cause problems in the reduction furnace.

Initially a bench scale reduction on a sample will be carried out based on the analysis from step A. The bench scale results and/or the equilibrium calculations will be used to determine the reduction time (Rt), reduction temperature (RT) and reducing gas flowrate (GF) for the bulk material reduction carried out in step B. Most likely this will be determined by setting the conditions to ensure the mass loss during the sample reduction is less than about 2% (2%+/−0.5%).

The results from step A may allow the optimum selection of the hydrogen concentration (HC) in the reducing gas (3) as the equilibrium/maximum reduction is determined by this.

In most cases the reduction temperature (RT) and reducing gas flowrate (GF) for step B will be predetermined, and the reduction time (Rt) set by the bench scale test. This allows a batch furnace to be maintained at a preset optimum temperature and reducing gas flowrate (GF) to be fixed to minimise entrainment of the EAFD. For a continuous furnace it allows the temperature and reducing gas flowrate (GF) to be optimally set, and the transport speed of EADF through the furnace to be adjusted to give the optimum reduction time (RT).

Step B is the partial reduction of the zinc ferrite in the EAFD to magnetite and zinc oxide without the formation of significant amounts of wustite, metallic iron or metallic zinc. This process is carried out in a furnace of known type and configuration. To minimise the formation of wustite, metallic iron or metallic zinc it is likely the mass loss during this step will be controlled to no more than about 2% (2%+/−0.5%). This is accomplished by using a reducing gas (2) including hydrogen in a carrier gas such as nitrogen or argon at temperatures below about 800° C. Most likely the processing will occur at between 500° C. and 750° C., and is believed that the optimum may lie between 650° C. and 750° C.

The fire or explosion risk will likely determine the maximum hydrogen concentration (HC) in the reducing gas (2). It is also likely that the maximum hydrogen concentration (HC) in the reducing gas (2) will vary with the processing equipment and safety requirements for the location.

Based on trials to date the reducing gas (2) is expected to be in a neutral carrier gas, such as nitrogen, containing from 0.25% to 10% hydrogen by volume, though a concentration of up to 70% hydrogen is felt to be the upper limit, and it is felt that below 66% is optimum.

Table 1, below, shows typical mass loss results for trial reductions of EAFD using a 5% (vol %) Hydrogen in nitrogen reducing gas (2).

TABLE 1

| | | | | | |
|---|---|---|---|---|---|
| Reduction | Reduction | 5% H₂ in N₂ | Mass | Mass | Mass |
| Temperature | Time | Flowrate | before | After | Loss |
| ° C. | Hours | cc/min | g | g | % |

Comparing reduction temperatures

| | | | | | |
|---|---|---|---|---|---|
| 600 | 1 | 100 | 2.11 | 2.076 | 1.6% |
| 650 | 1 | 100 | 2.606 | 2.555 | 2.0% |
| 700 | 1 | 100 | 2.7017 | 2.5438 | 5.8% |
| 850 | 1 | 100 | 2.636 | 2.352 | 10.8% |

Comparing reduction times

| | | | | | |
|---|---|---|---|---|---|
| 650 | 1 | 100 | 2.606 | 2.555 | 2.0% |
| 650 | 3 | 100 | 2.7424 | 2.5144 | 8.3% |

As can be seen, using a reducing gas (2) with 5 vol % hydrogen in a neutral carrier gas (nitrogen) the mass loss for this sample of EAFD is below about 2% if the reduction temperature (RT) is below 650° C. and the reduction time (Rt) is around 1 hour. The mass loss is approximately linear with regards to time so the effect of increasing the time can be determined. Increasing the reduction temperature (RT) also changes the mass loss, though not in a linear manner as reaction kinetics are more sensitive to temperature changes.

A mass loss of about 2% has been found to reduce the franklinite to zinc oxide and magnetite, with a low risk of reducing the magnetite to wustite or iron which is undesirable. However, a mass loss of greater than 2% without the formation of metallic iron, metallic zinc or wustite, or the loss of zinc, could be tolerated.

Table 2, below, has XRD analysis results of the reduced material (3) at a variety of reduction temperatures (RT) and reduction times (Rt).

TABLE 2

| | | | | Fe and Zn |
|---|---|---|---|---|
| Reduction | Reduction | Gas flow | Zinc | after furnace |
| Temperature | Time | (4% H2 in | Ferrite | treatment (magnetite |
| (RT) | (Rt). | N2) (GF) | reduction | and ZnO preferred) |
| [° C.] | [mins] | [cc/min] | [—] | [—] |
| 600 | 60 | 100 | Near | No metallic Fe, |
| | | | complete | some wustite |
| 650 | 60 | 100 | Complete | Some metallic Fe, |
| | | | | some wustite |
| 650 | 180 | 100 | Complete | Significant metallic |
| | | | | Fe, less wustite |
| 700 | 60 | 100 | Complete | Some metallic Fe, |
| | | | | some wustite |
| 700 | 60 | 30 | Complete | No metallic Fe, no |
| | | | | wustite |
| 850 | 60 | 100 | Complete | Fe same as 700° C., |
| | | | | but more Zn lost |

As can be seen the amount of metallic iron and wustite formed is determined by the reducing gas flowrate (GF), reduction time (Rt) and reduction temperature (RT). More results are needed to determine the optimum parameters based on total zinc and zinc ferrite fraction analysis carried out in step A.

The above said, it is felt that the optimum reduction temperature (RT) will be in the range of 500° C. to 800° C., most likely below about 700° C. to keep the metallic iron and wustite in the reduced material (3) low.

Example 1 has a theoretical thermodynamic analysis of the hydrogen reducing gas (2) results. If these calculations are confirmed with EAFD trials then to minimise wustite formation and effect a sufficient reduction of the zinc ferrite to zinc oxide then a molar excess of H₂ is required. The theoretical analysis suggests that a reduction temperature of 400° C. would achieve the desired result with a reducing gas (2) containing a 3 molar excess of Hydrogen

Once step B has been completed and the desired degree of reduction has been achieved step C is undertaken. Step C is the cooling of the reduced material (3) under reducing or neutral conditions until it is below 350° C., possibly even lower. If the reduced material is cooled in air above 400° C. then there is rapid formation of ZnFe₂O₄.

After cooling the reduced material (3) undergoes an optional step D which is an acid leaching step. It is expected that this will be using sulphuric acid at a pH below about 3.

### Best Mode for Carrying out the Invention

In a further variation of the method step A is again optional, though preferred, and the reducing gas (2) includes water at a molar ratio of H₂O:H₂ of 1:2 to 2:5 i.e. 2 molar parts hydrogen to 1 part water through to 5 molar parts hydrogen to 2 parts water. This changes the reductive effect of the reducing gas (2). It has been found that the water to hydrogen ratio range of 20:1 to 1:5 has the required properties.

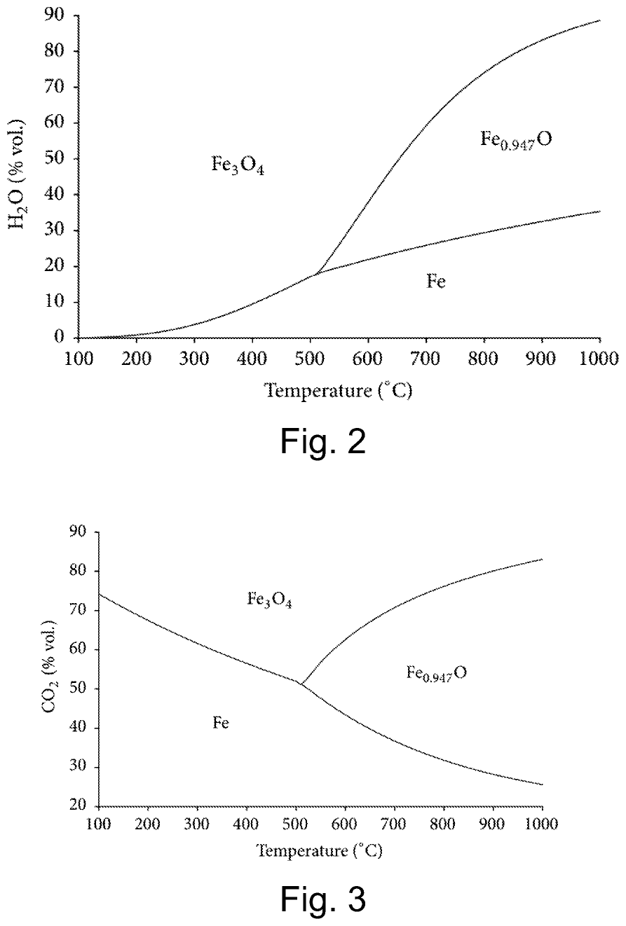

The use of H₂/H₂O results in a very different phase equilibria diagram, see FIG. 2, to that when CO/CO₂ is used, see FIG. 3. At equilibria the CO/CO₂ system favours the reduction to iron. At equilibria a H₂/H₂O reducing gas (2) favours the formation of magnetite. As such depending on whether the reducing gas contains hydrogen or it contains carbon monoxide the iron equilibria tended towards will be different.

The use of hydrogen and water in a neutral carrier gas (most likely nitrogen) as the reducing gas (2) has been found to provide a means of adjusting the reductive power of the reducing gas (2). By controlling the water vapour present it is possible to limit the reductive potential of the reducing gas (2) lowering the formation of undesirable species.

The water vapour concentration can be measured for the reducing gas (2) into the furnace and the spent reducing gas (2) exiting the furnace and by controlling the water content of the reducing gas (2) the reductive power of the reducing gas (2) can be controlled. Example 2 has a theoretical thermodynamic analysis of the water/hydrogen reducing gas (2) results, if these are confirmed with EAFD trials then to minimise wustite formation the temperature will need to be maintained at below 650° C.

In a further variant it is possible to add a small amount of carbon monoxide to the reducing gas (2). It is thought that a H₂:H₂O:CO ratio of 2:(1 to 10):(0 to 10) at a concentration of between 0.25% to 15% (by volume) in a neutral carrier gas will allow additional control of the reduction reaction that occurs. Of course, using CO is undesirable due to the environmental concerns, and it is an odourless poisonous gas which can make handling difficult, but it may improve the reaction kinetics thus reduce the energy input required.

In some variants step A and/or step D are not present. If step A is not present then step B is controlled by directly or indirectly measuring the extent of reduction by measuring the forms of iron present, and/or measuring the composition of the reducing gas (2) within the furnace or using a Thermal Conductivity Detector (TCD) on the exiting gas stream. Step D may not be undertaken if the reduced material (3) is stored or sent off site for further processing.

Monitoring and/or controlling the reaction in step B, whether other steps are present or not, can be by directly or indirectly measuring the extent of reduction by measuring the forms of iron present, and/or measuring the composition of the reducing gas (2) within the furnace and/or using a Thermal Conductivity Detector (TCD) on the exiting gas stream.

In some variants there is a hydrogen recycling loop which extracts the hydrogen from the exhaust gases. The exhaust gas is processed and this process returns either hydrogen for addition to a neutral carrier gas, or a reducing gas (2) containing hydrogen.

In some variants the composition of the reducing gas (2) in step B is intentionally changed over time, staying within the parameters given previously. This intentional change in the composition of the reducing gas (2) will most likely be accomplished by adding hydrogen or water at a predetermined time after step B commences, but before later steps occur. This predetermined time delay is most likely to be implemented when the method is implemented as a continuous process. For example the water could be added part way through step B to allow a rapid initial reaction to occur with the water added to mediate the reaction end point. This predetermined time delay is most likely to be determined before the temperature in step B reaches a certain value or falls within a certain range of values. It is expected that this predetermined time delay will be before the temperature reaches 650° C., 600° C., 550° C. or 500° C., and most likely when the temperature falls within a predetermined range for example 600° C. to 650° C., 550° C. to 600° C. or 500° C. to 550° C.

Thermodynamic simulations have predicted that the process will operate at up to about 1000° C. successfully, though the sample runs have been limited to 900° C. due to furnace limitations. We believe that the method will operate successfully, but not necessarily optimally, at temperatures up to about (+/−10%) 1000° C. and this is supported by thermodynamic simulations, as such about 1000° C. appears to be an upper practical limit. Processing below 800° C. has significant advantages so it is believed that 800° C. or below is the optimum range, with 500° C. to 750° C. and 550° C. to 650° C. ranges providing additional benefits such as controllability.

### EXAMPLES

### Theoretical Examples

### Example 1

Hydrogen reducing gas with no additional water, thermodynamic predictions for various reductants between 400° C.-700° C. are given below (FactSage calculation using the Equilib-Web):

The zinc ferrite reduction with hydrogen uses ⅓ H₂ per zinc ferrite:

3ZnFe₂O₄+H₂→3ZnO+2Fe₃O₄+H₂O (α)

Reacting 1 mol ZnFe₂O₄ with 1/3 mol H₂ (i.e. no excess) gives:

TABLE 3
Reduction of 1 mol ZnFe₂O₄ with ⅓ mol H₂ (1 atm) at different temperatures

| Temperature/° C. | 400 | 500 | 550 | 600 | 650 | 700 |
|---|---|---|---|---|---|---|
| ZnO/mol | 0.53 | 0.75 | 0.83 | 0.89 | 0.93 | 0.95 |
| ZnFe₂O₄/mol | 0.47 | 0.25 | 0.17 | 0.11 | 0.07 | 0.05 |
| Fe₃O₄/mol | 0.35 | 0.50 | 0.55 | 0.59 | 0.62 | 0.63 |
| FeO/mol | 0 | 0 | 0 | 0 | 0 | 0 |
| H₂/mol | 0.16 | 0.08 | 0.06 | 0.04 | 0.02 | 0.02 |
| Zn/mol (vapour) | 7 × 10⁻¹¹ | 5 × 10⁻⁹ | 3 × 10⁻⁹ | 1.2 × 10⁻⁷ | 4 × 10⁻⁷ | 1 × 10⁻⁶ |

To reach 95% with stoichiometric H₂ quantity, around 700° C. is needed.

Same calculations performed with 3×excess H₂:

TABLE 4
Reduction of 1 mol ZnFe₂O₄ with 1 mol H₂ (1 atm.) at different temperatures

| Temperature/C. | 400 | 500 | 550 | 600 | 650 | 700 |
|---|---|---|---|---|---|---|
| ZnO/mol | 1 | 1 | 1 | 1 | 1 | 1 |
| ZnFe₂O₄/mol | 0 | 0 | 0 | 0 | 0 | 0 |
| Fe₃O₄/mol | 0.67 | 0.67 | 0.67 | 0.67 | 0.59 | 0.51 |
| FeO/mol | 0 | 0 | 0 | 0 | 0.22 | 0.48 |
| H₂/mol | 0.67 | 0.67 | 0.67 | 0.67 | 0.59 | 0.51 |
| Zn/mol (vapour) | 4 × 10⁻¹⁰ | 9 × 10⁻⁸ | 8 × 10⁻⁷ | 6 × 10⁻⁶ | 2 × 10⁻⁵ | 7 × 10⁻⁵ |

Conclusion. Thermodynamics says to operate at below 700° C. excess H₂ is required (at 3×excess the equilibrium conversion can reach 100% at 400° C.). This will be fine as long a H₂ recycling can be implemented. This also shows that keeping temperatures below 650° C. could be useful to limit FeO (wustite) formation.

### Example 2

Water and Hydrogen reducing gas, thermodynamic predictions for various reductants 600° C. are given below (FactSage calculation using the Equilib-Web):

The reaction is:

3ZnFe₂O₄+H₂→3ZnO+2Fe₃O₄+H₂O (β)

Equilibrium calculations at 600° C. with 1 mol ZnFe₂O₄ with 1 mol H₂ (i.e. 3×excess) gives:

TABLE 5
Reduction of 1 mol ZnFe₂O₄ at 600 C. with different H₂:ZnFe₂O₄ mol ratios (1 atm)

| | H₂:ZnFe₂O₄ mol ratios | | | | | |
|---|---|---|---|---|---|---|
| | 1:3 | 1:2 | 1:1 | 1.17:1 | 3:2 | 2:1 |
| | (no excess) | (1.5x excess) | (3x excess) | (3.5x excess) | (4.5x excess) | (6x excess) |
| ZnFe₂O₄/mol | 0.114 | 0 | 0 | 0 | 0 | 0 |
| ZnO/mol | 0.886 | 1.0 | 0.9999 | 0.9999 | 0.9999 | 0.9999 |
| Fe₃O₄/mol | 0.591 | 0.6667 | 0.6667 | 0.633 | 0.528 | 0.371 |
| FeO/mol | 0 | 0 | 0 | 0.100 | 0.415 | 0.887 |

Thermodynamics shows that above 1:1 mol ratios, at 600° C., reduction of iron oxides to FeO will occur. Steam (water vapour) can limit the further reduction of iron oxides. Calculations at 6×excess (H₂:ZnFe₂O₄ mol ratio=2:1) show this effect.

TABLE 6
Reduction of 1 mol ZnFe₂O₄ with 2 mol H₂ at
600° C. with different H₂O:H₂ mol ratios (1 atm.)

| H₂O:H₂ mol ratios | 1:20 | 1:10 | 1:5 | 1:2 | 5:1 | 7:1 |
|---|---|---|---|---|---|---|
| ZnFe₂O₄/mol | 0 | 0 | 0 | 0 | 0 | 0.47 |
| ZnO/mol | 0.9999 | 0.9999 | 0.9999 | 0.9999 | 0.9999 | 0.53 |
| Fe₃O₄/mol | 0.44 | 0.508 | 0.645 | 0.6667 | 0.6667 | 0.35 |
| FeO/mol | 0.681 | 0.476 | 0.065 | 0 | 0 | 0 |

Adding small amounts of steam (1:5=steam at 20% of H₂) removes the reduction to FeO. Adding more than 6 mol steam (water vapour): 1 mol H₂, starts to limit ZnFe₂O₄ reduction.

TABLE 7
Reduction of 1 mol ZnFe₂O₄ with 10 mol H₂ at
600° C. with different H₂O:H₂ mol ratios (1 atm.)

| H₂O:H₂ mol ratios | 0:1 | 1:10 | 1:5 | 1:2 | 5:1 | 7:1 |
|---|---|---|---|---|---|---|
| ZnFe₂O₄/mol | 0 | 0 | 0 | 0 | 0 | 0 |
| ZnO/mol | 0.9999 | 0.9999 | 0.9999 | 0.9999 | 0.9999 | 0.9999 |
| Fe₃O₄/mol | (Fe forms) | (Fe forms) | 0 | 0.6667 | 0.6667 | 0.6667 |
| FeO/mol | 0.567 | 1.32 | 2.0 | 0 | 0 | 0 |

** at 7.5 mol H₂O:1 mol H₂, the zinc ferrite starts to not reduce. At 8:1, no zinc ferrite reduces

Tables 6 and 7 show that the addition of water vapour can prevent the over reduction of the zinc ferrites by favouring the formation of magnetite (Fe₃O₄).

### Example 3

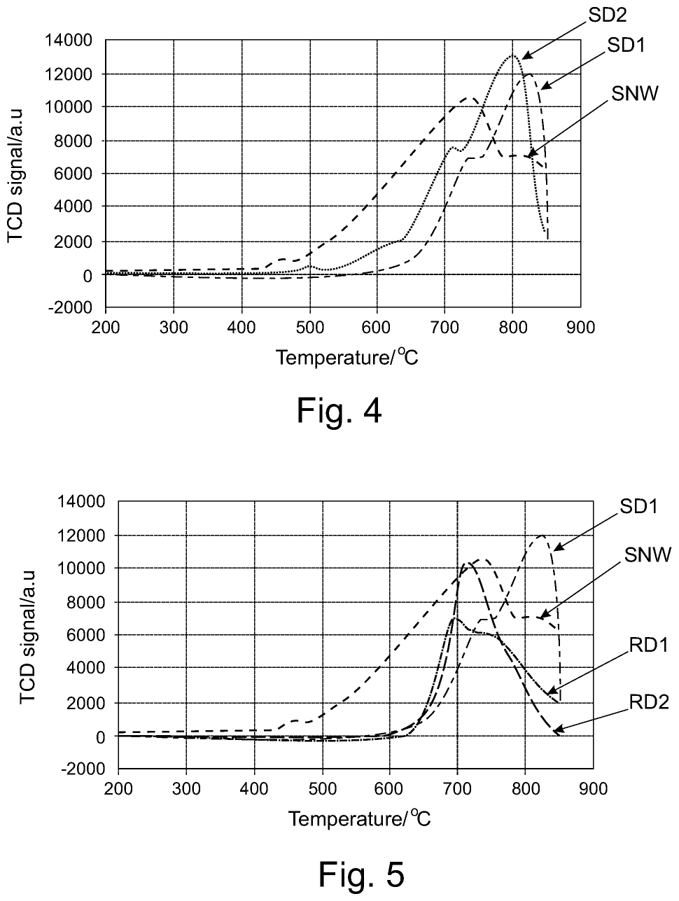

A programmed reduction of synthetic EAFD using no water and water:hydrogen ratios of 1.6:1 and 2.1:1 is shown in FIG. 4.

In this example 50 mg of a synthetic EAFD was heated from 100° C. to 850° C. in a 5% H₂ in Argon stream with a temperature increase of 20° C./minute. The outlet gas was monitored using a thermal conductivity detector. The detector effectively measures the hydrogen in the exit gas stream giving an indication of the reduction, the larger the number the greater the reduction that occurred.

In FIG. 4 line SNW is the synthetic EAFD where no water has been added, the line SD1 is where the water to hydrogen ratio is 1.6:1 (1.6 mole water to 1 mole hydrogen) and SD2 is where the water to hydrogen ratio is 2.1:1.

### Effect of Water to Hydrogen Ratio:

As can be seen by comparing the SNW to SD1 or SD2 the water addition slows the reaction rate and the reaction starts at a lower temperature. However, counterintuitively increasing the water: hydrogen ratio from 1.6:1 to.2.1:1 increases the reaction rate and causes it to commence at a lower temperature.

### Example 4

### Real EAFD vs Synthetic EAFD

The experiment carried out in Example 3 was repeated with two real EAFD's and a synthetic EAFD with the same zinc content and the results graphed in FIG. 5. The water to hydrogen ratio used was 1.6:1.

Referring to FIG. 5 the lines shown are:
SNW Synthetic EAFD with no water added;
SD1 Synthetic EAFD with a water to hydrogen ratio of 1.6:1;
RD1 Real EAFD sample 1 with a water to hydrogen ratio of 1.6:1; and
RD2 Real EAFD sample 2 with a water to hydrogen ratio of 1.6:1.

As can be seen it appears that the synthetic dust reaction rate occurs in two stages with the highest reaction rate occurring at around 820° C. whereas the real EAFD's (based on two actual samples which are believed to be representative) do not exhibit this apparent two stage process and have peak reaction rates over the range of 700° C. to 720° C. This means that the reaction characteristics of synthetic EAFD are not a good match for real EADF. Based on FIG. 5 using the synthetic EAFD results to optimise a real EAFD processing plant would result in designing for around 820° C. resulting in significantly lower reaction rates and higher energy use than using real EAFD in the optimisation trials. Based on these results experiments using synthetic EAFD cannot be used to determine reduction conditions for real EAFD processes with any reliability.

### Example 5

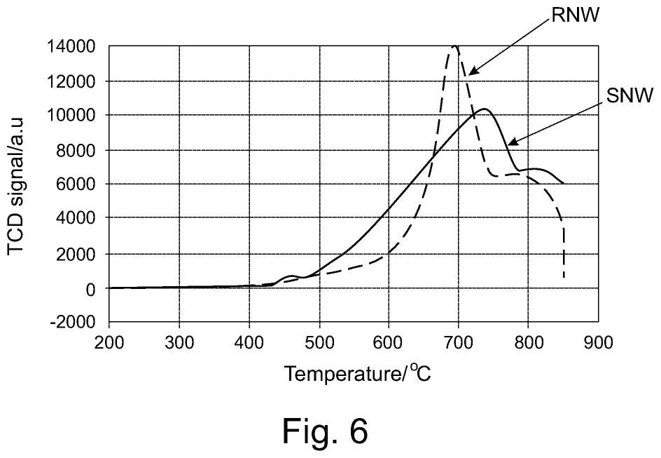

A programmed reduction of a synthetic EAFD and a real EAFD using no water is shown in FIG. 6.

In this example 50 mg of a synthetic EAFD and then a real EADF were heated from 100° C. to 850° C. in a 5% H₂ in Argon stream with a temperature increase of 20° C./minute. The outlet gas was monitored using a thermal conductivity detector. The detector effectively measures the hydrogen in the exit gas stream giving an indication of the reduction, the larger the number the greater the reduction that occurred.

In FIG. 6 the lines shown are:
SNW-synthetic dust, no water; and
RNW-real dust, no water.

As can be seen the reaction peak for the synthetic EAFD is lower and occurs at a higher temperature (˜720° C.) than the real EAFD. The reaction peak of the real dust occurs at about 690° C. and is about 40% higher. Interestingly the real EAFD peak is much narrower than the synthetic dust peak and as such this may allow specific optimisation of the reaction conditions. Once again, based on these results, experiments using synthetic EAFD cannot be used to determine reduction conditions for real EAFD processes with any reliability.

### KEY

1 source material (EAFD, BOFD),
2 reducing gas;
3 reduced material (material after partial reduction of source material using hydrogen containing reducing gas);
RT Reduction temperature
Rt Reduction time
HC Hydrogen concentration of reducing gas
HF reducing gas flowrate

1. A method for processing a source material containing zinc ferrite that includes the following step:
B. partially reduce source material using a reducing gas containing hydrogen to form a reduced material; wherein the reducing gas includes water.

2. The method as claimed in claim 1 wherein, step B is carried out at or below 1000° C.

3. The method as claimed in claim 1 wherein, the source material is a particulate material that is not pelletised before processing.

4-5. (canceled)

6. The method as claimed in claims 1 wherein, the source material is Electric Arc Furnace Dust (EAFD).

7-8. (canceled)

9. The method as claimed in claim 1 wherein, step B is carried out at between 500° C. and 750° C.

10-11. (canceled)

12. The method as claimed in claim 1 wherein, the method includes a step C, where step C cools the reduced material to a temperature no higher than 350° C. in an inert or reducing gas environment.

13. The method as claimed in claim 1 wherein, the hydrogen content of the reducing gas is between 0.25% and 10% by volume.

14. The method as claimed in claim 1 wherein, there is a step A preceding step B, where in step A the source material is analysed to determine the total zinc and/or zinc ferrite concentrations, wherein, Step A determines proposed processing conditions to be used in Step B, including reduction time (Rt), reduction temperature (RT) and reducing gas flowrate (GF).

15-20. (canceled)

21. The method as claimed in claim 1 wherein, the water is added to the reducing gas at a predetermined time after step B commences.

22. The method as claimed in claim 21 wherein, the predetermined time a. is reached before the temperature has reached a value selected from the list consisting of 500° C., 550° C., 600° C., and 650° C. or b. is reached when the temperature has a value within a range selected from the list consisting of 500° C. to 550° C., 550° C. to 600° C., 600° C. to 650° C., 500° C. to 600° C., 550° C. to 650° C. and 500° C. to 650° C.

23-28. (canceled)

29. The method as claimed in claims 1 wherein, after step C there is a step D, where step D is an acid leaching step.

30. The method as claimed in claim 29 wherein, the acid leaching step uses an acid leach which includes one or more acids selected from the list consisting of sulphuric acid, phosphoric acid, hydrochloric acid, hydrofluoric acid, and an organic acid with less than 15 carbon.

31. The method as claimed in claim 29 wherein, step D is carried out at a pH of less than 3.

32. The method as claimed in claim 31 wherein, step D is carried out at pH 2.

33. The method as claimed claim 30 wherein, the acid leach used contains sulphuric acid.

34. The method as claimed in claim 1 wherein, step B is monitored and/or controlled by one or more methods selected from the list consisting of directly or indirectly measuring the extent of reduction by determining the forms of iron present, determining the composition of the reducing gas within the furnace and determining the composition of an exiting gas stream.

35. (canceled)

36. The method of claim 1, wherein the ratio of water to hydrogen (H₂O:H₂), on a molar basis, is between 1:20 and 7:1.

37. The method of claim 1, wherein the water to hydrogen ratio is between 1:2 and 2:5.

38. The method of claim 1, wherein the method reduces the zinc ferrite to magnetite and zinc oxide whilst substantially avoiding the formation of wustite, iron or zinc.

39. The method of claim 1, wherein the mass loss during step B is controlled to no more than about 2% (2%+/−0.5%).
